(19) United States
(12) Patent Application Publication
(10) Pub. No.: US 2012/0311577 A1
(43) Pub. Date: Dec. 6, 2012

(54) SYSTEM AND METHOD FOR MONITORING VIRTUAL MACHINE

(75) Inventors: CHUNG-I LEE, Tu-Cheng (TW); CHIU-HUA LU, Tu-Cheng (TW); TSUNG-HSIN YEN, Tu-Cheng (TW); CHIEN-CHIH LIN, Tu-Cheng (TW)

(73) Assignee: HON HAI PRECISION INDUSTRY CO., LTD., Tu-Cheng (TW)

(21) Appl. No.: 13/453,357

(22) Filed: Apr. 23, 2012

(30) Foreign Application Priority Data
Jun. 1, 2011 (TW) 100119133

(51) Int. Cl. G06F 9/455; G06F 15/173

(52) U.S. Cl. 718/1

(57) ABSTRACT

A remote computer and method monitors a resource utilization rate of a cloud server of a datacenter. The remote computer obtains a resource utilization rate of each of virtual machines installed in the cloud server. The remote computer calculates the resource utilization rate of the cloud server according to the resource utilization rate of each of the virtual machines. The remote computer transfers one or more virtual machines from the cloud server to other cloud servers until the resource utilization rate of the cloud server is equal to or less than the predetermined resource utilization rate.

### BACKGROUND

1. Technical Field

Embodiments of the present disclosure relate to virtual machine technology, and particularly to a virtual machine monitoring system and method.

2. Description of Related Art

Virtual machine (VM)s are software implementation that virtualizes a personal computer or a server on an operating system (kernel) layer. By using the VMs, multiple operating systems can co-exist and run independently on the same computer. Each VM may use some resources (e.g., CPU time takes up part of the memory) of the computer. The computer may run too slow when the resources used by the VMs exceed a threshold. In such a situation, a user may shutdown or transfer one or more virtual machines from the computer to other computer, so as to reduce resource usage of the computer. However, for most VMs, the user manually transfers the virtual machine to another computer. This is tedious and time consuming and thus, there is room for improvement in the art.

### BRIEF DESCRIPTION OF THE DRAWINGS

FIG. 1 is a system view of one embodiment of a virtual machine monitoring system.

FIG. 2 is a block diagram of one embodiment of a remote computer included in FIG. 1.

FIG. 3 is a flowchart of one embodiment of a virtual machine monitoring method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

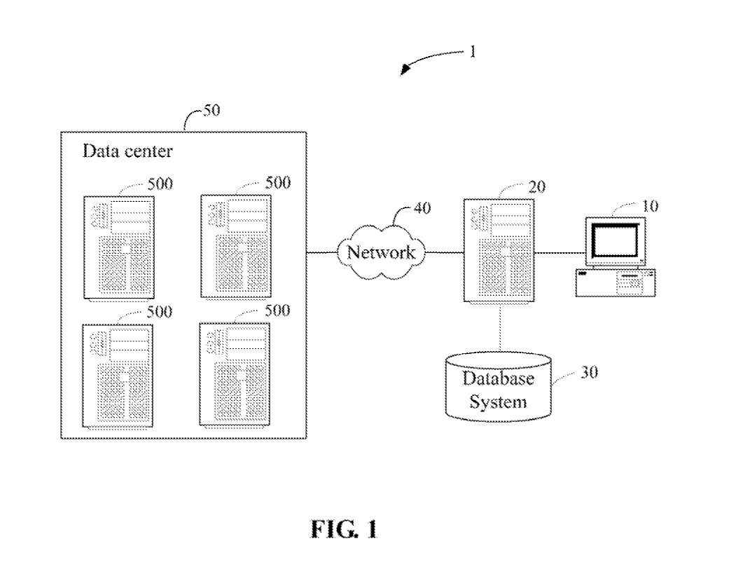

FIG. 1 is a system view of one embodiment of a virtual machine monitoring system 1. In this embodiment, the virtual machine monitoring system 1 may include a remote computer 20 and a data center 50. The data center 50 is designed for cloud computing capability and capacity including a plurality of cloud servers 500. The remote computer 20 is electronically connected to one or more client computers 10, the data center 50 via a network 40. The network 40 may be, but is not limited to, a wide area network (e.g., the Internet) or a local area network. The virtual machine monitoring system 1 may be used to monitor a resource utilization rate of each of the cloud servers 500. Using open database connectivity (ODBC) or java database connectivity (JDBC), for example, the remote computer 20 is electronically connected to a database system 30. The database system 30 may store the resource utilization rate, which is obtained by the remote computer 20. Additionally, each of the one or more client computers 10 provides an operation interface for controlling one or more operations of the remote computer 20.

The cloud servers 500 store the resource utilization rate. The resource utilization rate may show performance of the cloud servers 500 and be generated by the cloud servers 500 themselves when the cloud servers 500 run. For example, the resource utilization rate includes a CPU utilization rate of the cloud server 500, a memory utilization rate of the cloud server 500, a disk utilization rate of the cloud server 500, and a network traffic of the cloud server 500. Additionally, the cloud servers 500 may store a serial number of each cloud server 500, a voltage of the cloud server 500, a rotational speed of a fan of the cloud server 500, a temperature of the cloud server 500, a status of the cloud server 500 (e.g., power on/off).

The remote computer 20 stores a virtual machine image file. The virtual machine image file is defined as a compressed file that contains complete contents and structures of a virtual machine. A user can use the virtual machine image file to install one or more virtual machines in the cloud servers 500. In one embodiment, the virtual machine image file may be, but is not limited to, a VMWARE ESX. In order to manage the one or more virtual machines, each of the cloud servers 500 installs a virtual machine management application (e.g., HYPERVISOR). The HYPERVISOR is used to manage and monitor execution of the one or more virtual machines. The HYPERVISOR also obtains the resource utilization rate of each of the one or more virtual machines.

The remote computer 20, in one example, can be also a dynamic host configuration protocol (DHCP) server. The remote computer 20 is installed with a DHCP service. In one embodiment, the remote computer 20 assigns Internet protocol (IP) addresses to the cloud servers 500 by the DHCP service. The remote computer 20 may provide three modes for allocating IP addresses to the cloud servers 500. The modes are dynamic allocation, automatic allocation, and static allocation. In one embodiment, the remote computer 20 uses dynamic allocation to assign the IP addresses to the cloud servers 500. For example, when the remote computer 20 receives a request from a cloud server 500 via the network 40, the remote computer 20 dynamically assigns an IP address, and offers the remote computer 10 with the IP address. In this embodiment, the remote computer 20 may be a personal computer (PC), a network server, or any other data-processing equipment.

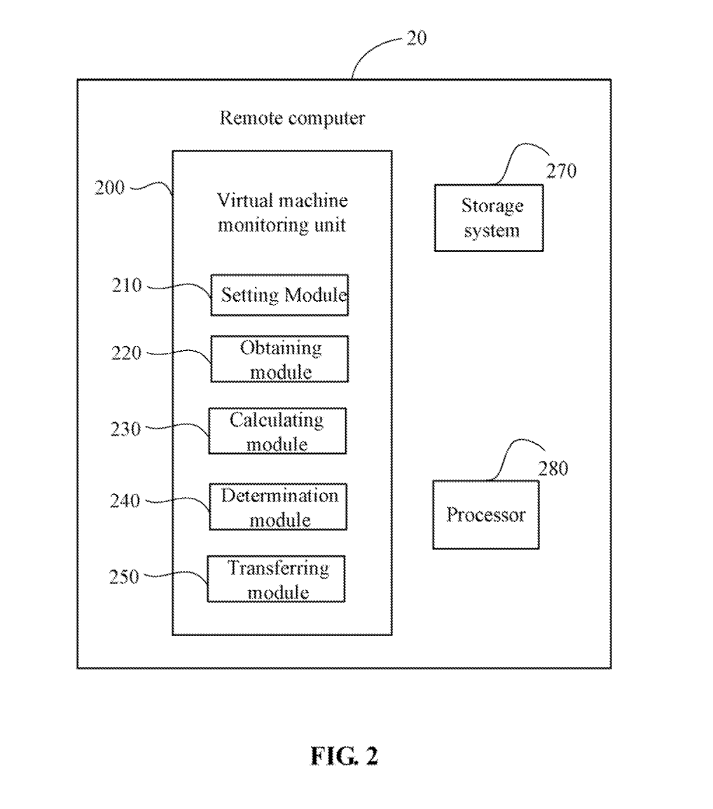

FIG. 2 is a block diagram of one embodiment of the remote computer 20. The remote computer 20 includes a virtual machine monitoring unit 200. The virtual machine monitoring unit 200 may be used to monitor the resource utilization rate in the cloud servers 500. The remote computer 20 includes a storage system 270, and at least one processor 280. In this embodiment, the virtual machine monitoring unit 200 includes a setting module 210, an assignment module 220, an obtaining module 230, a calculating module 240, a determination module 250, and a transferring module 250. The modules 210-260 may include computerized code in the form of one or more programs that are stored in the storage system 270. The computerized code includes instructions that are executed by the at least one processor 280 to provide functions for the modules 210-260. The storage system 270 may be a memory, such as an EPROM, HDD, or flash memory.

The setting module 210 sets a predetermined resource utilization rate for each of the cloud servers 500. In one embodiment, the predetermined resource utilization rate includes a predetermined CPU utilization rate of the cloud server 500, a predetermined memory utilization rate of the cloud server 500, a predetermined disk utilization rate of the cloud server 500, a predetermined network traffic of the cloud server 500.

The obtaining module 220 obtains a resource utilization rate of each of the virtual machines in the cloud server 500. In one embodiment, the obtaining module 220 obtains the resource utilization rate of each of the virtual machines from the HYPERVISOR installed in the cloud server 500.

The calculating module 230 calculates the resource utilization rate of the cloud server 500 according to the resource utilization rate of each of the virtual machines. In one embodiment, the CPU utilization rate of the cloud server 500 is equal to a summation of all CPU utilization rates of the virtual machines. The memory utilization rate of the cloud server 500 is equal to the summation of all memory utilization rates of the virtual machines. The disk utilization rate of the cloud server 500 is equal to the summation of all disk utilization rates of the virtual machines. The network traffic of the cloud server 500 is equal to the summation of all network traffic of the virtual machines.

The determination module 240 determines if the calculated resource utilization rate is greater than the predetermined resource utilization rate. In one embodiment, the calculated CPU utilization rate is greater than the predetermined CPU utilization rate, or the calculated memory utilization rate is greater than the predetermined memory utilization rate, or the calculated disk utilization rate is greater than the predetermined disk utilization rate, or the calculated network traffic is greater than the predetermined network traffic, then the calculated resource utilization rate is greater than the predetermined resource utilization rate.

In other words, the calculated resource utilization rate includes four parameters, if one of the parameters is greater than corresponding predetermined parameter, then the calculated resource utilization rate is greater than the predetermined resource utilization rate. For example, if the calculated CPU utilization rate is greater than the predetermined CPU utilization rate, regardless of the calculated memory utilization rate, the calculated disk utilization rate and the network traffic, the calculated resource utilization rate is greater than the predetermined resource utilization rate.

Additionally, the determination module 240 adds a time factor to determine if the calculated resource utilization rate is greater than the predetermined resource utilization rate. For example, if the calculated CPU utilization rate is greater than the predetermined CPU utilization rate and such a situation lasts for five minutes, the determination module 250 determines the calculated resource utilization rate is greater than the predetermined resource utilization rate.

The transferring module 250 transfers one or more virtual machines from the cloud server 500 to other cloud servers 500 until the resource utilization rate of the cloud server 500 is equal to or less than the predetermined resource utilization rate, in the respond to a determination that the calculated resource utilization rate is greater than predetermined resource utilization rate. In one embodiment, the transferring module 250 invokes HYPERVISOR to transfer the one or more virtual machines.

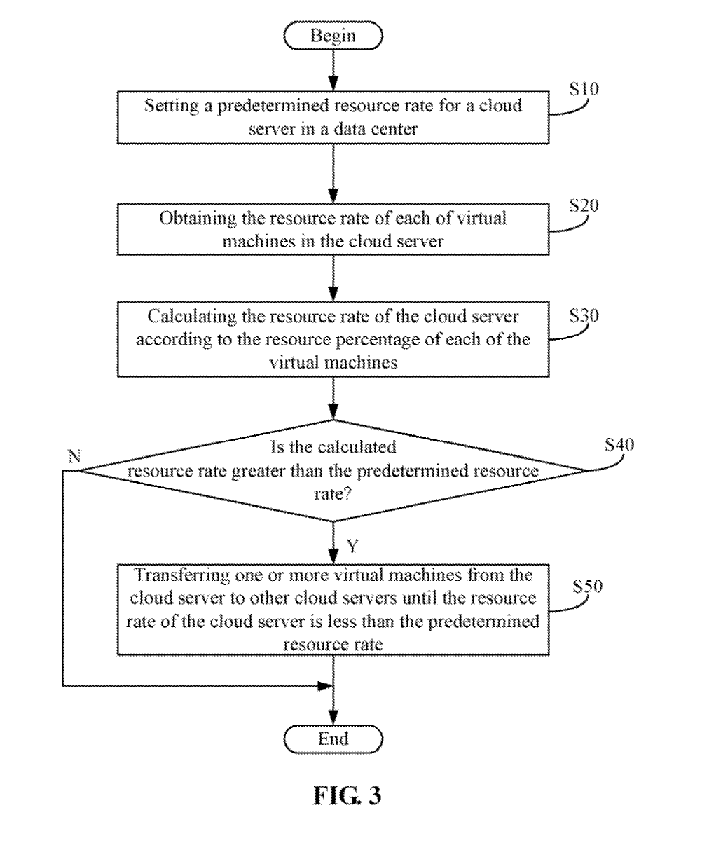

FIG. 3 is a flowchart of one embodiment of a virtual machine monitoring method. Depending on the embodiment, additional steps may be added, others deleted, and the ordering of the steps may be changed.

In step S10, the setting module 210 sets a predetermined resource utilization rate for each of the cloud servers 500. As mentioned above, a predetermined CPU utilization rate of the cloud server 500 is set as 80% (e.g., a percentage capacity usage of a CPU). A predetermined memory utilization rate of the cloud server 500 is set as 85% (e.g., a percentage capacity usage of memory). A predetermined disk utilization rate of the cloud server 500 is 85% (e.g., a percentage capacity usage of a disk). In addition, a predetermined network traffic of the cloud server 500 is set as fifty GB.

In step S20, the obtaining module 220 obtains a resource utilization rate of each of the virtual machines in the cloud server 500. In one embodiment, the obtaining module 220 obtains the resource utilization rate of each of the virtual machines from the HYPERVISOR installed in the cloud server 500.

In step S30, the calculating module 230 calculates the resource utilization rate of the cloud server 500 according to the resource utilization rate of each of the virtual machines. For example, assuming that the cloud server 500 includes two virtual machines A and B, if the CPU utilization rate of the virtual machine A is 30% and the CPU utilization rate of the virtual machine B is 20%, then the CPU utilization rate of the cloud server 500 is equal to 50%. If the memory utilization rate of the virtual machine A is 20% and the memory utilization rate of the virtual machine B is 20%, then the memory utilization rate of the cloud server 500 is equal to 40%. If the disk utilization rate of the virtual machine A is 21% and the disk utilization rate of the virtual machine B is 20%, then the disk utilization rate of the cloud server 500 is equal to 41%. If the network traffic of the virtual machine A is five GB and the network traffic of the virtual machine B is six GB, then the network traffic of the cloud server 500 is equal to eleven GB.

In step S40, the determination module 240 determines if the calculated resource utilization rate is greater than the predetermined resource utilization rate. In one embodiment, if the disk utilization rate of the virtual machine A is 61% and the disk utilization rate of the virtual machine B is 22%, the calculated resource utilization rate is greater than the predetermined resource utilization rate 80%, the procedure goes to step S50. Otherwise, if the calculated CPU utilization rate is 78%, the calculated memory utilization rate is 80%, the calculated disk utilization rate is 81%, and the calculated network traffic utilization rate is 30 GB, the calculated resource utilization rate is equal to or less than the predetermined resource utilization rate, the procedure ends.

In step S50, the transferring module 250 transfers one or more virtual machines from the cloud server 500 to other cloud servers 500 until the resource utilization rate of the cloud server is equal to or less than the predetermined resource utilization rate. For example, if the disk utilization rate of the virtual machine A is 61% and the disk utilization rate of the virtual machine B is 22%, the transferring module 250 invokes HYPERVISOR to transfer the virtual machine A to another cloud server 500. Additionally, the transferring module 250 checks the resource utilization rate of the another cloud server 500 to make sure that the another cloud server 500 are not overloading.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A remote computer, the remote computer in electronic communication with a cloud server of a data center, comprising:
a storage system;
at least one processor; and
one or more programs stored in the storage system and being executable by the at least one processor, the one or more programs comprising:
an obtaining module operable to obtain a resource utilization rate of each of virtual machines installed in the cloud server;
a calculating module operable to calculate the resource utilization rate of the cloud server according to the resource utilization rate of each of the virtual machines;
a determination module operable to determine if the calculated resource utilization rate is greater than a predetermined resource utilization rate of the cloud server; and
a transferring module operable to transfer one or more virtual machines from the cloud server to other cloud servers until the resource utilization rate of the cloud server is equal to or less than the predetermined resource utilization rate.

2. The remote computer of claim 1, wherein the calculated resource utilization rate of the cloud server and the predetermined resource utilization rate of the cloud server comprise a CPU utilization rate of the cloud server, a memory utilization rate of the cloud server, a disk utilization rate of the cloud server, a network traffic of the cloud server.

3. The remote computer of claim 1, wherein the cloud server is installed with a virtual machine management application.

4. The remote computer of claim 3, wherein the virtual machine management application is HYPERVISOR.

5. The remote computer of claim 4, wherein the obtaining module obtains the resource utilization rate of each of the virtual machines from the HYPERVISOR.

6. The remote computer of claim 4, wherein the transferring module transfers the one or more virtual machines from the cloud server to other cloud servers using the HYPERVISOR.

7. A computer-based virtual machine monitoring method being performed by execution of computer readable program code by a processor of a remote computer, the remote computer in electronic communication with a cloud server of a data center, the method comprising:
obtaining a resource utilization rate of each of virtual machines installed in the cloud server;
calculating the resource utilization rate of the cloud server according to the resource utilization rate of each of the virtual machines;
determining if the calculated resource utilization rate is greater than a predetermined resource utilization rate of the cloud server; and
transferring one or more virtual machines from the cloud server to other cloud servers until the resource utilization rate of the cloud server is equal to or less than the predetermined resource utilization rate.

8. The method of claim 7, wherein the calculated resource utilization rate of the cloud server and the predetermined resource utilization rate of the cloud server comprise a CPU utilization rate of the cloud server, a memory utilization rate of the cloud server, a disk utilization rate of the cloud server, a network traffic of the cloud server.

9. The method of claim 7, wherein the cloud server is installed with a virtual machine management application.

10. The method of claim 9, wherein the virtual machine management application is HYPERVISOR.

11. The method of claim 10, wherein the resource utilization rate of each of the virtual machines is obtained from the HYPERVISOR.

12. The method of claim 10, wherein the one or more virtual machines are transferred from the cloud server to other cloud servers using the HYPERVISOR.

13. A non-transitory computer-readable medium having stored thereon instructions that, when executed by a remote computer, the remote computer in electronic communication with a cloud server of a data center, causing the remote computer to perform a virtual machine monitoring method, the method comprising:
obtaining a resource utilization rate of each of virtual machines installed in the cloud server;
calculating the resource utilization rate of the cloud server according to the resource utilization rate of each of the virtual machines;
determining if the calculated resource utilization rate is greater than a predetermined resource utilization rate of the cloud server; and
transferring one or more virtual machines from the cloud server to other cloud servers until the resource utilization rate of the cloud server is equal to or less than the predetermined resource utilization rate.

14. The non-transitory medium of claim 13, wherein the calculated resource utilization rate of the cloud server and the predetermined resource utilization rate of the cloud server comprise a CPU utilization rate of the cloud server, a memory utilization rate of the cloud server, a disk utilization rate of the cloud server, a network traffic of the cloud server.

15. The non-transitory medium of claim 13, wherein the cloud server is installed with a virtual machine management application.

16. The non-transitory medium of claim 15, wherein the virtual machine management application is HYPERVISOR.

17. The non-transitory medium of claim 16, wherein the resource utilization rate of each of the virtual machines is obtained from the HYPERVISOR.

18. The non-transitory medium of claim 16, wherein the one or more virtual machines are transferred from the cloud server to other cloud servers using the HYPERSIOR.
